(19) United States
(12) Patent Application Publication
(10) Pub. No.: US 2014/0345299 A1
(43) Pub. Date: Nov. 27, 2014

(54) METHOD OF MARINE TRANSPORTATION OF UNSWEETENED NATURAL GAS

(71) Applicant: Woodside Energy Technologies Pty Ltd., Perth (AU)

(72) Inventors: David Kirk, Applecross (AU); Adrian Armstrong Macmillan, Floreat (AU); Nigel James Palmer, East Victoria Park (AU)

(21) Appl. No.: 14/345,021

(22) PCT Filed: Sep. 17, 2012
(86) PCT No.: PCT/AU2012/001113

§ 371 Date: Mar. 14, 2014

(30) Foreign Application Priority Data
Sep. 16, 2011 (AU) 2011903801
Oct. 4, 2011 (AU) 2011904090

(51) Int. Cl. F17C 13/08; B63B 35/00

(52) U.S. Cl. CPC F17C 13/082; B63B 35/00
USPC 62/53.2

(57) ABSTRACT

Marine transportation of natural gas is disclosed, including: a) removing a free water stream and a condensate stream from the source of raw natural gas to produce a dew-pointed unsweetened natural gas stream at an offshore supply location; b) subjecting the dew-pointed unsweetened natural gas stream to a selected level of dehydration to produce a partially dehydrated unsweetened natural gas stream at the offshore supply location; and c) transporting at least a portion of the partially dehydrated unsweetened natural gas stream in a gas containment system onboard a gas carrier vessel from the offshore supply location as a feed source of natural gas to an acid gas removal facility or an LNG production facility located at an offloading location.

### FIELD OF THE INVENTION

The present invention relates to a method and a system for marine transportation of unsweetened natural gas. The present invention is specifically, though not exclusively applicable to the offshore transportation of unsweetened gas from deepwater stranded or sour gas reserves as a source of feed gas to an LNG production facility.

### BACKGROUND TO THE INVENTION

Burning natural gas produces less carbon dioxide than any other fossil fuel with the result that the use of natural gas has increased significantly in the recent past. Over three-quarters of the world's known offshore gas reserves of natural gas remain undeveloped due to the high cost of transportation. These reserves are found in far off and remote locations as “gas pools” or gas associated with oil production. The size of these gas pools is often substantial (typically 8.0 TCF and below), yet they remain below the critical size required for the economics demanded for new long-term LNG development. Many of these gas reserves are located offshore in places from which the gas cannot be economically transported by way of a pipeline or have reserves which have insufficient gas volumes to support a traditional deepwater gas processing facility. Such reserves are referred to in the art as “stranded gas” reserves. Stranded natural gas can arise due to the inaccessible nature of the source of gas, for example gas associated in deepwater reservoirs, and also through the remoteness of the source from its market.

Various schemes have been proposed to allow production of gas from stranded gas reserves. Liquefied natural gas (LNG) occupies 600 times less space than natural gas in its gaseous phase. It is thus generally accepted that in order to transport natural gas economically from one location over long distances to another, it must be treated at an LNG production plant to remove impurities prior to being cooled to −162 degrees Celsius to produce LNG in a process referred to in the art as “liquefaction”. The LNG is stored in cryogenic storage facilities from where the LNG is pumped onboard purpose built LNG carriers which are specially constructed to store and transport the cryogenic liquid at atmospheric pressure conditions. The LNG carriers deliver the LNG cargoes to import terminals where regasification is conducted prior to delivery of the highly treated natural gas to market.

LNG production plants require high upfront capital in the order of billions of dollars for commercial scale operations, and are for the most part land based. Recently, floating LNG liquefaction plants have been proposed as an option to allow LNG to be produced and stored offshore. U.S. Pat. No. 6,003,603 (Breivik) and US Patent Publication number 20030226376 (Pribble) teach the use of two ships for the processing and storage of offshore natural gas. The first ship includes a field installation for gas treatment. The treated gas is then transferred in compressed form to a floating LNG tanker for liquefaction with the LNG produced being stored onboard the floating LNG tanker. Once full, the LNG tanker is disconnected from a buoy to which it is attached and sets sail. Another LNG tanker takes its place to receive the treated inlet gas for liquefaction. Other schemes rely on locating a traditional LNG processing plant on the top of a dedicated floating barge or purpose built marine vessel that is equipped with gas processing, liquefaction and storage facilities on a single vessel. Such floating LNG concepts remain prohibitively expensive for the monetisation of stranded gas reserves.

Bulk compressed natural gas (CNG) transport has been used on land for over thirty years. CNG marine transportation has been contemplated for use on short distance projects (up to 2000 nautical miles one-way distance to market). By way of example, U.S. Pat. No. 7,240,498 and related U.S. Pat. No. 7,155,918 describe a method for processing and transporting compressed natural gas using a floating vessel by obtaining pressurized high-energy content gas and separating the pressurized product stream into saturated gas, a natural gas liquid, and a condensate. Impurities are removed from the saturated gas to create a decontaminated saturated gas. The types of impurities removed from the saturated gas are the sour gas species (specifically carbon dioxide and hydrogen sulphide) and mercury. The sweetened saturated gas is then dehydrated to remove water forming a dry sweetened pressurized gas. The dry pressurized gas is cooled to form a two-phase gas having a vapour phase and a liquid phase. This two-phase gas is then loaded into a double-walled storage element, followed by the condensate and the natural gas liquid being loaded into the double-walled storage element forming a mixture. The pressure of the mixture is maintained within the double-walled storage element at a pressure ranging from 55 bar (800 psi) to 83 bar (1200 psi) during transport of the floating vessel with the loaded double-walled storage element to a desired location. As the mixture in the double-walled storage element warms during transit, vapour gas is formed and this vapour phase, in the form of a high pressure boil-off gas, is used to power the power plant onboard the vessel after blending it with diesel fuel. The floating vessel described in U.S. Pat. No. 7,240,498 and related U.S. Pat. No. 7,155,918 is fitted with all of the processing equipment required to sweeten, dehydrate, cool and compress the gas so that no additional processing is required when the floating vessel arrives at the delivery location. The topside complexity of the floating vessel is so prohibitively expensive as to not be commercially viable.

International Patent Publication Number WO2009/124372 relies on the use of a small vessel, preferably of the catamaran type which collects natural gas from an offshore source such as a fixed rig or a well or a sub-sea separation system having equipment to transfer the gas to the surface and connection to the catamaran. The catamaran carries a natural gas treatment plant that includes condensate compressors, CNG storage tanks, a decontaminating unit to remove any sour gas species (including carbon dioxide and hydrogen sulphide) present in the collected gas, a dehydration unit for performing deep dehydration of the sweetened gas, and inter-phase heat exchangers refrigerated with a suitable cooling means, for example, sea water or atmospheric air, preferably sea water. All operations, including; collection, pre-treatment (decontamination by way of gas sweetening), dehydration (removing water), compression, storage and offloading of compressed natural gas and of the condensables, are carried out on board the catamaran. The liquids and condensates separated during the method of obtaining CNG are stored in tanks situated on the lower deck of the vessel for subsequent offloading on land or on the rig itself or support structure of the collection of gas from the supply source. The catamaran vessel described in International Patent Publication Number WO2009/124372 is fitted with all of the processing equipment required to sweeten, dehydrate, cool and compress the gas so that no additional processing is required when the floating vessel arrives at the offloading location. Again, the topside complexity of the floating vessel is so prohibitively expensive as to not be commercially viable.

European Patent Publication Number EP 0130066 describes a method and system for producing raw natural gas from wells located offshore, and making the raw natural gas available to a terminal installation. A watercraft, such as a barge or ship, carrying pressure vessel means is transported to an offshore well and moored using a loading mooring system. A discrete batch of raw natural gas and any accompanying liquids are then stored in the pressure vessel means onboard the watercraft. This batch of raw natural gas is not subjected to any kind of gas processing prior to transport. The watercraft is moved to a processing station located remote from the offshore well. The discrete batch of raw natural gas and any accompanying liquids are then unloaded into the processing station. The processing location can be onshore or at another offshore well at which a platform and processing equipment have previously been erected, and to which a pipeline has been built. The raw natural gas is then processed at the processing station to produce processed natural gas suitable for further transmission and transport. The raw natural gas is carried in the pressure vessel means under high pressure (in the range of between 138 bar (2000 psi) and 217 bar (3000 psi)) without the need for refrigeration equipment. In order to prevent the formation of gas hydrate and or ice crystals during off-loading of the raw natural gas from the pressure vessel means at the processing location, a hydrate inhibitor agent such as glycol is injected into the storage vessels before or during the unloading of the raw gas at the processing location. Transport of raw natural gas in the manner described in EP 0130066 has never been constructed in practice because of corrosion problems associated with attempting to store and transport non-dehydrated sour gas in a pressure vessel means made of carbon steel construction. Such corrosion problems are particularly acute when the raw gas is collected from a sour gas field.

CNG solutions which rely on chilling treated natural gas have also been proposed but never constructed. Storage of CNG at temperatures below −46 degrees Celsius requires materials of construction which are more exotic and therefore more expensive than carbon steel. To achieve the low storage temperatures whilst avoiding the formation of freezable solids, such processes require deep dehydration of the gas (using, for example, molecular sieves). These prior art systems further include facilities for the removal of CO₂ which forms solids at −78 degrees Celsius at atmospheric pressure. Another option that has been proposed but never constructed is to transport compressed natural gas within a liquid matrix of liquid hydrocarbons (“NGLs”) as a “compressed natural gas liquid” (CNGL). These theoretical CNGL carriers are fitted with onboard processing equipment to load a deeply dehydrated sweetened natural gas in order to convert this to a liquefied cargo. Such CNGL carriers further require an onboard offloading process train to separate the natural gas from its NGL carrier liquid. Again, the topside complexity of the floating vessel is so prohibitively expensive as to not be commercially viable.

Although gas demand is growing, a simple economically viable marine transportation system is still required to monetise the smaller or “stranded” reserves. Current LNG and proposed CNG solutions are not economical for the development of remote, sour, or stranded gas reserves. There remains a need to provide systems and methods that facilitate economic development of remote, sour gas, or stranded gas reserves to be realized by a means not afforded by prior art liquid natural gas (LNG) or prior art compressed natural gas (CNG) systems. Improved processes for the transportation of natural gas to enable the full utilisation of stranded gas reserves would be highly desirable.

### SUMMARY OF THE INVENTION

According to a first aspect of the present invention there is provided a method of marine transportation of natural gas comprising the steps of:

a) removing a free water stream and a condensate stream from the source of raw natural gas to produce a dew-pointed unsweetened natural gas stream at an offshore supply location;

b) subjecting the dew-pointed unsweetened natural gas stream to a selected level of dehydration to produce a partially dehydrated unsweetened natural gas stream at the offshore supply location;

c) transporting at least a portion of the partially dehydrated unsweetened natural gas stream in a gas containment system onboard a gas carrier vessel from the offshore supply location as a feed source of natural gas to an acid gas removal facility or an LNG production facility located at an offloading location.

In one form, the gas containment system has a first operating pressure in the range of 200 to 250 bar, and the gas containment system has a first operating temperature is at ambient temperature or near-ambient temperature, and wherein the level of dehydration is less than 200 mg/Sm³. In one form, the dew-pointed unsweetened gas is treated with a liquid or solid desiccant to achieve the selected level of dehydration of less than 200 mg/Sm³.

In another form, the gas containment system has a first operating pressure in range of 100 to 150 bar, and the gas containment system has a first operating temperature is in the range of −25 to −40 degrees Celsius, and wherein the level of dehydration is less than 5 mg/Sm³. In one form, the gas containment system has a first operating temperature below zero degrees Celsius and the method includes the step of chilling at least a portion of the dew-pointed unsweetened natural gas stream to form a chilled gas stream having a level of dehydration less than 5 mg/Sm³. In one form, a liquid desiccant is formed by injection of a stream of glycol into a portion of the dew-pointed unsweetened natural gas stream prior to the step of subjecting the dew-pointed unsweetened natural gas stream to chilling.

In one form, the method includes the step of recovering the glycol in a glycol recovery unit. In one form, the step of recovering the glycol is conducted onboard the gas carrier. In one form, the step of recovering the glycol is conducted at the offloading location. In one form, the step of subjecting the dew-pointed or partially dehydrated unsweetened gas stream to compression prior to loading onboard the gas carrier vessel. In one form, step c) includes transporting at least a portion of the condensate stream in a condensate containment system onboard the gas carrier vessel from an offshore supply location to an offloading location. In one form, the gas containment system has a first operating pressure and the condensate containment system has a second operating pressure, and wherein the first operating pressure is matched to the second operating pressure and step c) includes regulating the ratio of condensate to gas to form a blended stream having a feed gas composition that falls within the operating envelope of the acid gas removal facility or an LNG production facility. In one form, the supply location is a deepwater gas reservoir, a stranded gas reservoir, a sour gas reservoir, a stranded gas pool, or gas associated with an oil reservoir. In one form, the offshore supply location is located 100 to 1,000 km from the offloading location. In one form, the acid gas removal facility is located onshore or offshore. In one form, the acid gas removal facility is associated with an LNG production facility. In one form, the LNG production facility is a fixed or floating LNG production facility.

In one form, at least a portion of the partially dehydrated unsweetened natural gas stream is blended with at least one source of natural gas at a gas processing hub to form a blended stream delivered through an export pipeline from the gas processing hub as the feed source of natural gas to the acid gas removal facility of the LNG production facility. In one form, the gas carrier vessel travels a distance of 500 to 1000 kilometers from the supply location to the gas processing hub and the gas processing hub is located no more than 1000 kilometers from the LNG production facility.

In one form, the acid gas removal facility is positioned at a first location for receiving the partially dehydrated unsweetened natural gas from the gas carrier vessel to produce a sweetened natural gas stream for delivery to a second location that is spaced apart from the first location, and wherein a liquefaction facility which produces LNG is positioned at the second location.

In one form, the method includes the step of returning the gas carrier vessel from the offloading location to the supply location with the gas carrier vessel being loaded with one or more byproducts of an LNG production facility. In one form, the one or more byproducts of the LNG production facility is liquefied petroleum gas, stabilized condensate, carbon dioxide, propane, butane or dry monoethylene glycol. In one form, the step of returning the gas carrier vessel from the offloading location to the supply location comprises loading a stream of carbon dioxide onboard the gas carrier vessel for re-injection into an offshore storage reservoir. In one form, the supply location is one of a plurality of supply locations.

According to a second aspect of the present invention there is provided a system for marine transportation of natural gas comprising:
a gas/liquid separator for receiving a source of raw natural gas from an offshore supply location and removing a free water stream and a condensate stream from the source of raw natural gas to produce a dew-pointed unsweetened natural gas stream;
a dehydration unit for subjecting the dew-pointed unsweetened natural gas stream to a selected level of dehydration to produce a partially dehydrated unsweetened natural gas stream at the offshore supply location;
a gas carrier vessel for transporting at least a portion of the partially dehydrated unsweetened natural gas stream in a gas containment system onboard a gas carrier vessel from the offshore supply location as a feed source of natural gas to an acid gas removal facility or an LNG production facility located at an offloading location.

In one form, the LNG production facility is a fixed or floating LNG production facility. In one form, the supply location is located 100 to 1000 km from the offloading location. In one form, the supply location is a deepwater gas reservoir, a stranded gas reservoir, a stranded gas pool, a sour gas reservoir, or gas associated with an oil reservoir. In one form, the supply location is one of a plurality of supply locations.

In one form, the system includes a gas containment system onboard the gas carrier vessel for storing at least a portion of the partially dehydrated unsweetened natural gas at a first operating pressure and a first storage temperature. In one form, the system includes a condensate containment system onboard the gas carrier vessel for storing at least a portion of the condensate stream at a second operating pressure and a second storage temperature. In one form, the system includes a compression facility for subjecting the dew-pointed natural gas stream or the partially dehydrated unsweetened natural gas stream to compression prior to loading onboard the gas carrier vessel. In one form, the compression facility is located upstream or downstream from the dehydration unit. In one form, the dehydration unit and the compression facility are located onboard the gas carrier vessel. In one form, the gas/liquid separator is located on the seabed. In one form, the compression facility is located on the seabed

In one form, the gas carrier vessel includes a power generation system for generating electricity capable of providing power for transportation of the gas carrier vessel from the supply location to the offloading location. In one form, the power generation system provides power to one or all of the compression facility, the dehydration unit, and the gas/liquid separator.

In one form, the gas/liquid separator, the compression facility, and the dehydration unit are located on a floating structure at a supply location. In one form, the floating structure comprises a buffer gas containment system for storage of a portion of the partially dehydrated unsweetened natural gas stream. In one form, the floating structure comprises a buffer liquid containment system for storage of a portion of the condensate stream. In one form, the floating structure is a marine transportation vessel, a semi-submersible platform, a tender-assisted self-erecting structure, a tension-leg platform, a normally unmanned platform, a satellite platform, or a spar.

In one form, the system includes a chiller for chilling of at least a portion of the partially dehydrated unsweetened natural gas prior to storage in the gas containment system. In one form, the system includes a glycol storage unit for providing a stream of glycol for injection into the dew-pointed natural gas stream upstream of the chiller. In one form, the system includes a glycol recovery unit for regenerating glycol. In one form, the glycol recovery unit is a part of the LNG production facility or an acid gas removal facility. In one form, the chiller and the glycol recovery unit are located on a floating structure. In one form, the chiller is located on the gas carrier vessel.

In one form, the LNG production facility is located onshore or offshore whilst the offloading location is an offshore gas processing hub arranged to receive at least one source of natural gas via a production riser associated with a subsea well located adjacent to or in the vicinity of the gas processing hub. In one form, at least a portion of the partially dehydrated unsweetened natural gas is blended with the at least one source of natural gas to form a blended stream delivered through an export pipeline from the gas processing hub as the feed source of natural gas to the LNG production facility. In one form, the gas carrier vessel travels a distance of 500 to 1000 kilometers from the supply location to the gas processing hub while the gas processing hub is located no more than 1000 kilometers from the LNG production facility. In one form, the LNG production facility includes a gas processing facility at a first location spaced apart from a liquefaction facility at a second location. In one form, the gas processing facility receives the partially dehydrated unsweetened natural gas from the gas carrier vessel and delivers a stream of dry sweet natural gas to the liquefaction facility which produces LNG. In one form, the gas processing facility is positioned on a fixed barge or floating structure and the first location is offshore while the second location is onshore. In one form, the gas processing facility is located on a floating structure or vessel offshore while the liquefaction facility is located on a floating LNG vessel and the second location is offshore.

### BRIEF DESCRIPTION OF THE DRAWINGS

In order to facilitate a more detailed understanding of the nature of the invention several embodiments of the present invention will now be described in detail, by way of example only, with reference to the accompanying drawings, in which:

FIG. 1 is a schematic plan view of a first embodiment of the present invention showing a gas carrier vessel at an offshore supply location;

FIG. 2 is a schematic process flow diagram of an embodiment of the present invention which does not include a compression facility;

FIG. 3A is a schematic process flow diagram of an embodiment of the present invention in which the dehydration unit is located downstream of the compression facility;

FIG. 3B is a schematic process flow diagram of an alternative embodiment of the present invention in which the dehydration unit is located upstream of the compression facility;

FIG. 4 is a schematic plan view of an embodiment of the present invention showing two gas carrier vessels at an offshore supply location for continuous production;

FIG. 5 is a schematic plan view of an embodiment of the present invention showing a floating structure and a gas carrier vessel at an offshore supply location;

FIG. 6 is a schematic process flow diagram of an embodiment of the present invention including chilling;

FIG. 7 is a schematic plan view of another embodiment of the present invention showing a floating structure and a gas carrier vessel at an offshore supply location with minimal topsides on the floating structure;

FIG. 8 is a is a schematic plan view of an embodiment of a gas carrier vessel at an offloading location associated with an onshore LNG facility;

FIG. 9 is a is a schematic plan view of an embodiment of a gas carrier vessel at an offloading location associated with a floating LNG facility;

FIG. 10 is a is a schematic plan view of an embodiment of a gas carrier vessel at an offloading location comprising a gas processing hub feeding gas into a pipeline associated with an onshore LNG facility;

FIG. 11 is a is a schematic plan view of an embodiment of a gas carrier vessel at an offloading location associated with an LNG facility with a gas processing facility that is separate from an onshore liquefaction facility;

FIG. 12 is a is a schematic plan view of an embodiment of a gas carrier vessel at an offloading location associated with an offshore LNG facility with a gas processing facility that is separate from a floating liquefaction facility; and,

FIG. 13 is a schematic plan view showing a plurality of gas carrier vessels moving from a supply location to an offloading location and then returning back to the supply location.

It is to be noted that the drawings illustrate only preferred embodiments of the invention and are therefore not to be considered limiting of the invention's scope as it may admit to other equally effective embodiments. Like reference numerals refer to like parts. The components in the figures are not necessarily to scale, emphasis instead being placed upon illustrating the principles of the invention. Moreover, all drawings are intended to convey concepts, where relative sizes, shapes and other detailed attributes may be illustrated schematically rather than literally or precisely.

### DETAILED DESCRIPTION OF PREFERRED EMBODIMENTS

Particular embodiments of the method and system for marine transportation of unsweetened natural gas of the present invention are now described. The terminology used herein is for the purpose of describing particular embodiments only, and is not intended to limit the scope of the present invention. Unless defined otherwise, all technical and scientific terms used herein have the same meanings as commonly understood by one of ordinary skill in the art to which this invention belongs.

The term “ambient temperature” is used herein to refer to a temperature in the range of 20 to 25 degrees Celsius.

In the description and claims to follow the term “raw natural gas” refers to untreated natural gas and hydrocarbon liquids that are extracted from a reservoir. The composition of the raw natural gas will depend on such relevant factors as the type, depth, and location of the reservoir from which the natural gas has been produced. In terms of hydrocarbons, raw natural gas contains predominantly methane (CH₄) with varying amounts of other heavier gaseous hydrocarbons, including: ethane (C₂H₆); propane (C₃H₈); butane (n-C₄H₁₀); isobutane (i-C₄H₁₀); pentanes (C₅H₁₂) and the so-called “heavy hydrocarbons” which are hydrocarbons that have more than five carbon molecules (C5+) in the chain. Raw natural gas may also contain mercury, nitrogen, and varying concentrations of the “acid gas species” and “sour gas species”. The “acid gas species” include carbon dioxide (CO₂), hydrogen sulphide (H₂S) and mercaptans. The “sour gas species” include hydrogen sulphide and organosulphur compounds. When the raw natural gas is removed from the wellhead, it contains water in vapour and liquid form including liquid water present in the reservoir. The liquid water from the reservoir and that which condenses out of a raw natural gas stream due to the dew point of the gas at a particular temperature and pressure is referred to in the art as “free water”. The raw natural gas removed from the wellhead also contains liquid hydrocarbons referred to in the art as “unstabilised condensate”. Throughout this specification, the phrase “dew-pointed natural gas” is used to refer to a raw natural gas stream that has been subjected to gas/liquid separation (to remove free water and partially stabilised condensate as a function of the dew point conditions, that is, the separation pressure and temperature of the gas). The term “unsweetened natural gas” refers to a stream of natural gas that has not been subjected to any process for removal of the acid gas or sour gas species.

The system and method of marine transportation of unsweetened natural gas of the present invention relies on the transportation of partially dehydrated unsweetened natural gas from an offshore supply location to an offloading location associated with an acid gas removal facility or an LNG production facility. As a first step, a free water stream and an unstabilised condensate stream are removed from a source of raw natural gas at the offshore supply location using gas/liquid separation to produce a dew-pointed unsweetened natural gas stream. The dew-pointed unsweetened natural gas stream is then subjected to a selected level of dehydration to produce a partially dehydrated unsweetened natural gas stream at the offshore supply location. The selected level of dehydration depends on a number of relevant factors including the material of construction of the gas containment system that is intended to be used to store the gas after dehydration. At least a portion of the partially dehydrated unsweetened natural gas stream is thereafter transported in a gas containment system onboard a gas carrier vessel from the offshore supply location to the offloading location to be used as a feed source of gas to the acid gas removal facility located at the offloading location. In preferred embodiments of the present invention, the acid gas removal facility is associated with an LNG production facility.

The overarching goal of the system and method of the present invention is to keep the costs associated with gas pre-treatment at the offshore supply location to a minimum prior to loading of the gas onto the gas carrier vessel. Prior to transport, the raw natural gas is not subjected to the traditional gas sweetening processes of the prior art. Accordingly, using the system and method of the present invention, the gas carrier vessel is not fitted with sour gas removal facilities or prior art acid gas removal facilities, such as the amine treating facilities which are traditionally associated with a CO₂ removal unit. In this way, the topsides complexity of the gas carrier vessel is kept to a minimum. Analogously, mercury and nitrogen removal, if required, is conducted using equipment located at an offloading location associated with an LNG production facility.

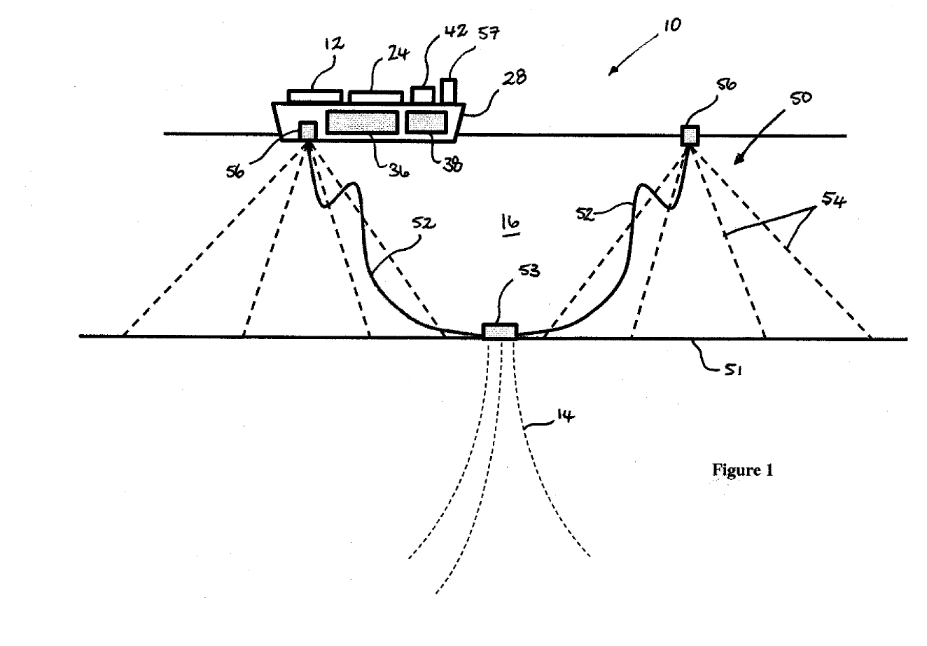

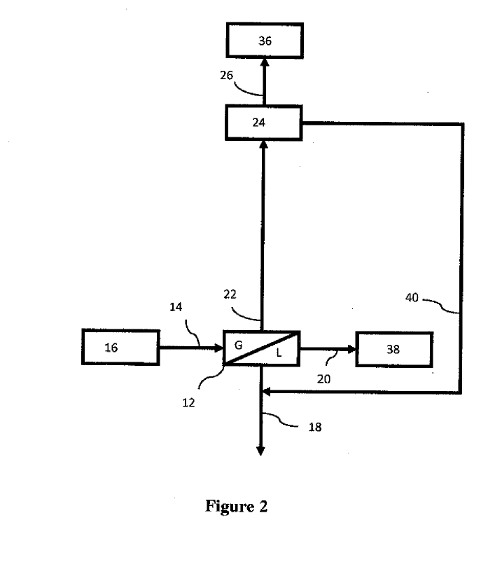

With reference to FIGS. 1 and 2, there is provided a system (10) for marine transportation of natural gas which system includes a gas/liquid separator (12) for receiving a source of raw natural gas (14) from an offshore supply location (16) and removing a free water stream (18) and an unstabilised condensate stream (20) from the source of raw natural gas (14) to produce a dew-pointed unsweetened natural gas stream (22). The dew-pointed unsweetened natural gas stream (22) is directed to a dehydration unit (24) located downstream of the gas/liquid separator (12), to remove water vapour from the dew-pointed unsweetened natural gas stream (22) to a selected level of dehydration so as to produce a partially dehydrated unsweetened natural gas stream (26).

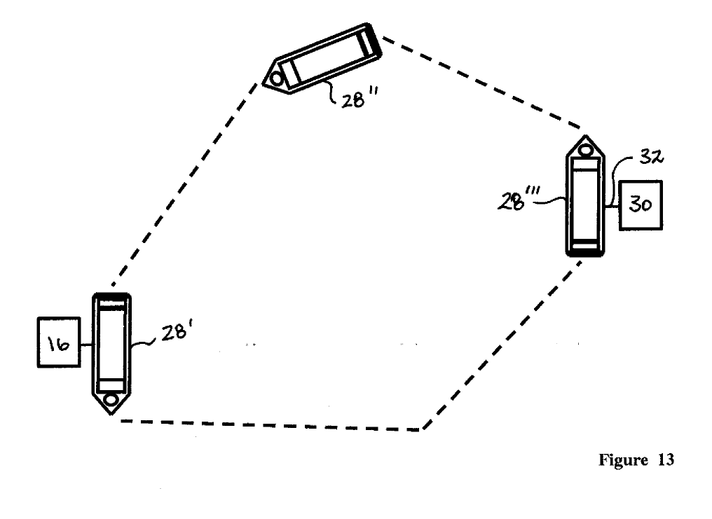

Referring to FIGS. 1 and 13, a gas carrier vessel (28) is used to transport the partially dehydrated unsweetened natural gas from the offshore supply location (16) to an offloading location (30) where the partially dehydrated unsweetened natural gas stream is used as a feed source of unsweetened natural gas (32) to an acid gas removal facility (34). The acid gas removal facility (34) may be located either onshore or offshore at a fixed or floating LNG production facility (35) as described in greater detail below. The distance travelled by the gas carrier vessel (28) from the supply location (16) to the offloading location (30) may vary. The present invention is particularly suited to the marine transportation of natural gas from a supply location that is located at a distance from an offloading location that is greater than the distance considered to be economically viable for pipeline construction, operation and maintenance. By way of example, a supply location may be 100 to 1,000 km from an offloading location. The raw natural gas may be sourced from one or a plurality of offshore supply locations. The present invention is particularly suited to the monetisation of deepwater gas reservoirs, stranded gas reservoirs or pools, sour gas reservoirs, or gas associated with oil reserves (“associated gas”) including associated gas that is located close to an offloading location.

At least a portion of the partially dehydrated unsweetened natural gas (26) is stored in a gas containment system (36) at a first operating pressure and a first storage temperature. At least a portion of the stream of unstabilized condensate (20) is stored in a condensate containment system (38) at a second operating pressure and a second storage temperature. In one embodiment of the present invention, the first operating pressure is matched to the second operating pressure, so that when the gas carrier vessel (28) is transported to an offloading location (30), the partially dehydrated unsweetened natural gas and the unstabilised condensate can be more easily offloaded together such that the feed source of natural gas (32) is a blended stream. The ratio of condensate to gas can be regulated to ensure that the overall feed gas composition falls within the operating envelope of the acid gas removal facility (34) or LNG production facility (35).

The level of dehydration achieved using the dehydration unit is selected to reduce the risk of corrosion of the materials of construction of the gas containment system, to reduce the risk of producing solid carbon dioxide or ice when the option is taken to chill the gas prior to transport, and/or, to reduce the risk of undesirable gas hydrate formation during offloading of the partially dehydrated unsweetened gas at the offloading location. The selected level of dehydration can be a high level of dehydration (below 5 mg/Sm³) in order to facilitate the use of less expensive carbon steel materials of construction of the gas containment system at temperatures less than zero degrees Celsius. Alternatively, the selected level of dehydration can be a low level of dehydration (below 200 mg/Sm³) when the gas containment system is constructed, or lined with, a more expensive but more corrosion resistant combination of materials such as a filament wound composite held in place by a polymer or a carbon fibre composite wrapped around a metal liner or a composite overwrapped pressure vessel used at or above ambient temperature storage conditions.

In a first embodiment of the present invention which is now described with reference to FIGS. 1 and 2, the gas containment system (36) and the condensate containment system (38) are both located onboard the gas carrier vessel (28). The first operating pressure of the gas containment system (36) is in the range of 200 to 250 bar (2900 to 3600 psi) with the first storage temperature being at or above ambient temperature. Using this embodiment of the system and method of the present invention, the raw natural gas is maintained in gaseous form in stark contrast to prior art offshore LNG and CNGL solutions. Again, this is done in order to keep the topside complexity of the gas carrier vessel to a minimum and reduce the costs associated with construction and operation of low temperature or cryogenic liquid containment systems. Under these conditions of temperature and pressure, the dehydration unit (24) takes the form of a circulating glycol system using a liquid dessicant dehydration system, for example, triethylene glycol (TEG), to achieve a low selected level of dehydration of less than 200 mg/Sm³. In the process of achieving the selected level of dehydration of the unsweetened gas, the dehydration unit (24) separates out a stream of water (40) that is either directly disposed of as water vapour or combined with the stream of free water (18) removed by the gas/liquid separator (12) for disposal as wastewater via injection well or disposal to sea after suitable treatment to remove undesirable contaminants. In this embodiment, the unstabilised condensate is stored at a second operating pressure that is at or below the pressure in the gas-liquid separator (12) with the second operating temperature being at or above ambient temperature.

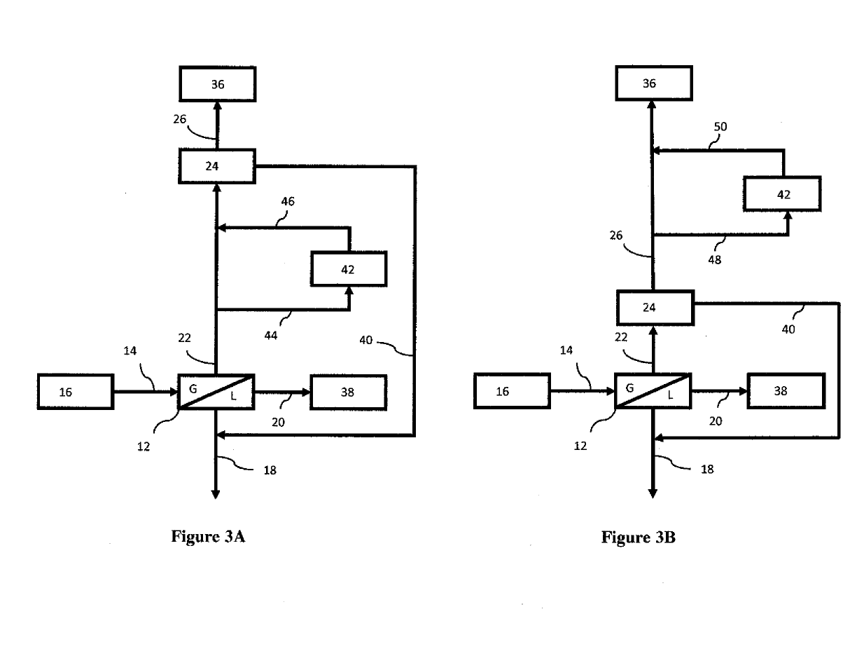

When the present invention is applied to the recovery of raw natural gas from deepwater reservoirs or low pressure small scale stranded or sour gas reservoirs, the wellhead pressure associated with the reservoir at the supply location may be lower than the first operating pressure of the gas containment system. In such circumstances, the unsweetened gas is subjected to compression prior to loading into the gas containment system onboard the gas carrier vessel. The level of compression required is a function of such relevant factors as the reservoir pressure and temperature conditions, the gas composition and the first operating pressure. Thus, when the wellhead pressure associated with the reservoir at the supply location (16) is lower than the first operating pressure of the gas containment system (36), the system of the present invention is further provided with a compression facility (42) located either upstream of the dehydration unit (24) as shown in FIG. 3A or downstream of the dehydration unit as shown in FIG. 3B. It is to be clearly understood that if the first operating pressure of the gas containment system is lower than the wellhead pressure associated with the reservoir, the system of the present invention does not require the inclusion of the compression facility (as shown in FIG. 2), leading to a further saving in the overall complexity and cost of the system. However, the use of compression under such circumstances, though entirely optional, may be more efficient.

In the embodiment illustrated in FIG. 3A, the compression facility (42) is located upstream of the dehydration unit (24) and is arranged to receive a side-stream (44) of the dew-pointed unsweetened natural gas stream (22) at an inlet pressure and produce a compressed dew-pointed unsweetened natural gas stream (46) having an outlet pressure that is greater than the inlet pressure. In this way, the compression facility (42) is used to boost the pressure of side-stream (44) so that the overall inlet pressure of the partially dehydrated unsweetened natural gas stream (26) that is fed to the gas containment system (36) matches the first operating pressure of the gas containment system (36). It is to be understood that the side-stream (44) may comprise some or all of the dew-pointed unsweetened natural gas stream (22).

In an alternative embodiment illustrated in FIG. 3B, the dehydration unit (24) is located downstream of the compression facility (42). Using this arrangement, the compression facility (42) is arranged to receive a side-stream (48) of partially dehydrated unsweetened natural gas and produce a compressed partially dehydrated unsweetened natural gas stream (50) having an outlet pressure greater than the inlet pressure of the side-stream (48). In this way, the compression facility (42) is used to boost the pressure of side-stream (48) so that the overall inlet pressure of the partially dehydrated unsweetened natural gas stream (26) that is fed to the gas containment system (36) matches the first operating pressure of the gas containment system (36). It is to be understood that the side-stream (48) may comprise some or all of the partially dehydrated unsweetened natural gas stream (26).

Returning to FIG. 1, the system (10) includes a mooring system (50) and associated marine riser (52) for transferring the raw natural gas stream (14) from a wellhead (53) to the gas/liquid separator (12). The mooring system (50) includes plurality of mooring lines (54) extending from a submersible disconnectable mooring buoy (56) to the seabed (51). Using this arrangement, the gas carrier vessel (28) is able to connect with a mooring buoy (56) upon arrival at the supply location (16) and weathervanes around that mooring buoy during loading operations. In one embodiment, the system (10) includes a plurality marine risers (52) for delivering a portion of the raw natural gas stream (14) to each of a corresponding plurality of mooring buoys (56). In the embodiment illustrated in FIG. 1, by way of example, the marine riser system (52) relies on the use of two mooring buoys (56) to facilitate continuous supply of unsweetened natural gas to a plurality of gas carrier vessels (28) which operate in sequence. The number of gas carrier vessels (28) required to achieve continuous operation depends on a number of relevant factors including the storage capacity of the gas containment system onboard each gas carrier vessel and the distance between the supply location (16) and the offloading location (30). By way of example, a first gas carrier vessel (28′) may be loading at a supply location (16), whilst a second gas carrier vessel (28″) is in transit between the supply location (16) and the offloading location (30) with a third gas carrier vessel (28′″) is being unloaded at the offloading location (30) as illustrated in FIG. 13.

As an alternative, a single mooring buoy (56) and associated mooring system (50) and marine riser system (52) may be used in which case production of fluids from the supply location (16) will need to be interrupted to allow for disconnection of a first gas carrier vessel and reconnection of a second gas carrier vessel. As a further alternative, the mooring system may comprise a pencil buoy (not shown) that can be retrieved and pulled up onto the deck edge of the gas carrier vessel where it is clamped to create a rigid connection for feeding the gas into a manifold on the gas carrier vessel. Using this alternative arrangement, the gas carrier vessel relies on dynamic positioning to maintain heading control.

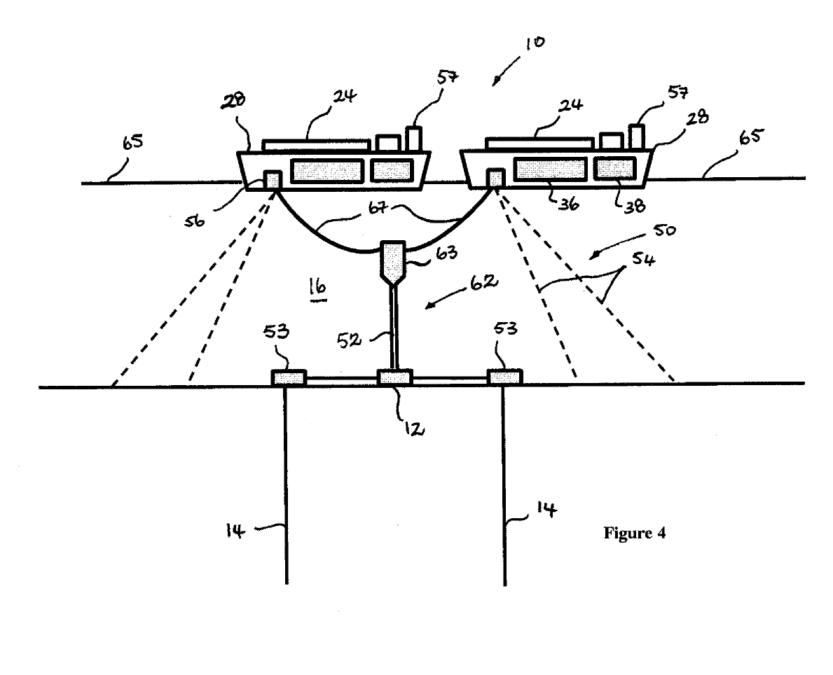

In the embodiment illustrated in FIG. 4, a vertically compliant marine riser system (62) is used in order to reduce or eliminate the need to conduct hydrate management on a continuous basis (for example, to reduce or eliminate the need to use a continuous monoethylene glycol (MEG) system). In this embodiment, the source of raw natural gas (14) from one or more reservoirs at the offshore supply location (16) is fed to the gas/liquid separator (12) onboard the gas carrier vessel (28) through a marine riser (52) that is kept vertical or near-vertical during production. The marine riser system (62) includes a tensioning means (63), such as a buoyancy module to keep the marine riser (52) in tension. With reference to FIG. 4, the buoyancy module (63) is positioned below the surface (65) of the water at a depth that is below the effect of waves to minimise environmental loads on the marine riser. By way of example, the buoyancy module may be positioned between 30 and 100 m meters below the surface of the water so as to keep the marine riser vertical whilst maintaining tension on the marine riser at all times. One or more flexible fluid connectors (67), such as a flexible jumper, are then used to direct the flow of the raw natural gas stream (14) from the marine riser (52) into the gas containment system (36) of the gas carrier vessel (28) via one or more mooring buoys (56).

Each gas carrier vessel (28) is provided with a power generation system (57) for generating electricity capable of providing power for transportation of the gas carrier vessel (28) from the supply location (16) to the offloading location (30). Suitable power generation systems include a generator such as a dual fuel gas turbine, dual fuel diesel or a steam boiler. Whilst it is highly desirable that the gas carrier vessel is self propelled, the system and method of the present invention is applicable to the use of gas carrier vessels that act as shuttles, each shuttle being moved from the supply location to the offloading location by way of use of a tugboat or equivalent.

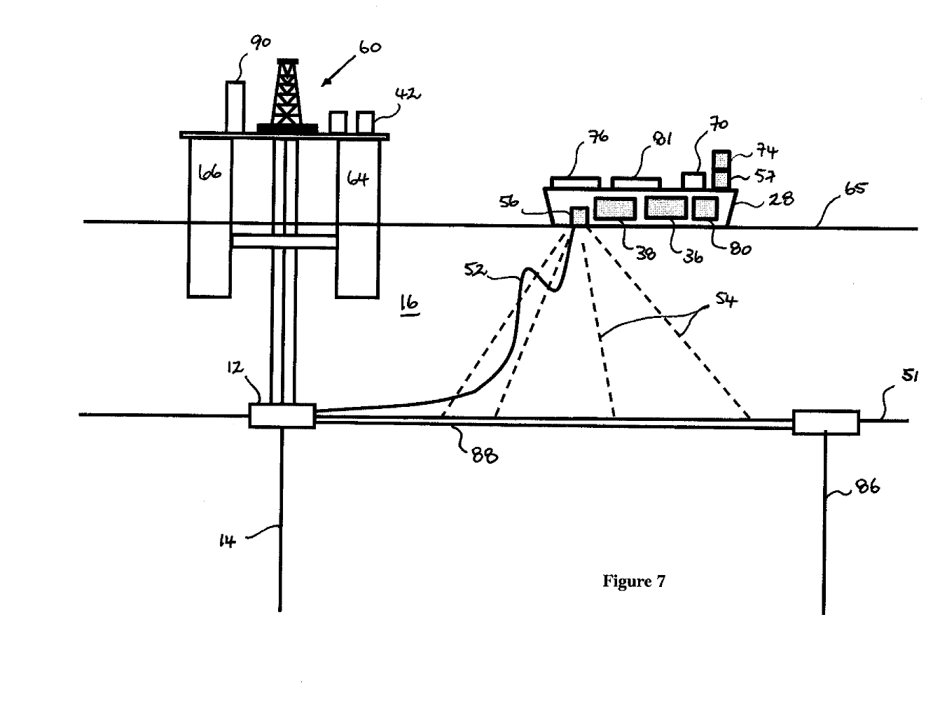

In the embodiment of the present invention that is illustrated in FIG. 1, the gas/liquid separator (12), the dehydration unit (24) and the compression facility (42), assuming that one is required, are located onboard the gas carrier vessel (28). Using this embodiment, the power generation system (57) onboard the gas carrier vessel (28) is used to provide power to the compression facility (42) and the dehydration unit (24) as well as any associated valves and pumps. Alternatively, one or both of the gas/liquid separator (12) and optional compression facility (42) could be located on the seabed (51) as illustrated in FIGS. 4 and 7, respectively, with the option of using umbilicals to draw power from the power generation system (57) onboard the gas carrier vessel to provide power to the subsea gas/liquid separator (12) and compression facility (42). Electing to place both the gas/liquid separator (12) and the compression facility (42) on the seabed further reduces the topside complexity of the gas carrier vessel (28).

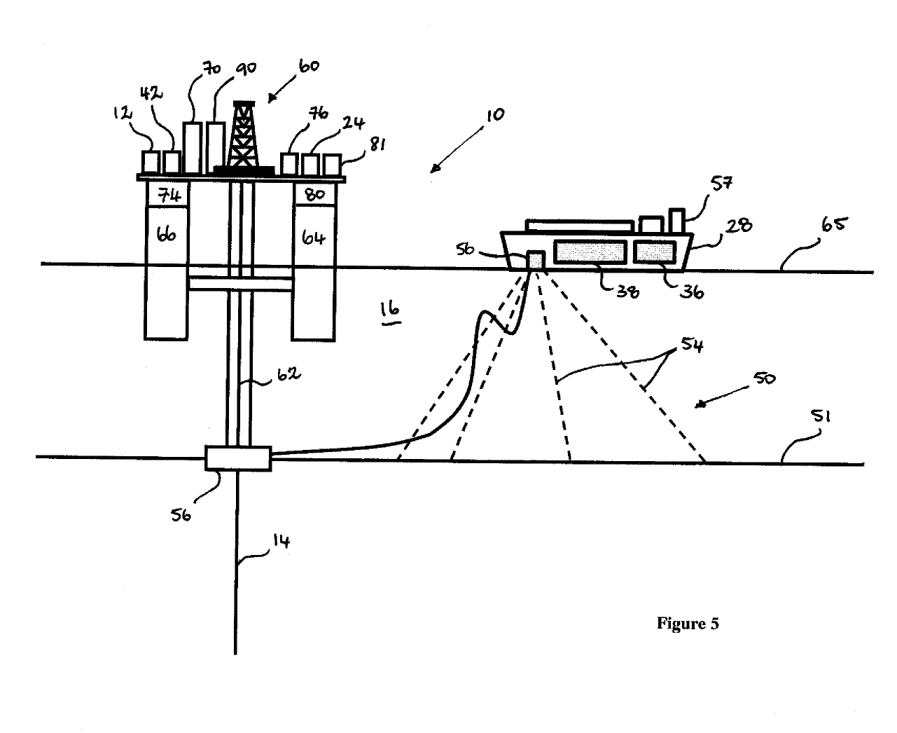

A second embodiment of the present invention is now described with reference to FIG. 5 in which the gas/liquid separator (12), the optional compression facility (42) and the dehydration unit (24) are located on a floating structure (60). Locating the gas/liquid separator (12), the dehydration unit (24) and the compression facility (42) on the floating structure (60) is done to keep the topsides infrastructure required onboard the gas carrier vessel (28) to an absolute minimum to reduce both the cost and the complexity of the gas carrier vessel (28). The floating structure (60) is provided with a buffer gas containment system (64) for storage of a portion of the partially dehydrated unsweetened natural gas stream (26) pending return of a gas carrier vessel (28). The floating structure (60) may be further provided with a buffer liquid containment system (66) for storage of a portion of the unstabilised condensate stream (20) or stabilised condensate pending return of a gas carrier vessel (28). Examples of suitable floating structures include a marine transportation vessel, semi-submersible platform, a tender-assisted self-erecting structure, a tension-leg platform, a normally unmanned platform, a satellite platform, or a spar. By way of example the floating structure may be a marine transportation vessel that is provided with its own propulsion system that is capable of relocating the vessel under its own propulsion in the event of adverse weather conditions such as a cyclone or hurricane.

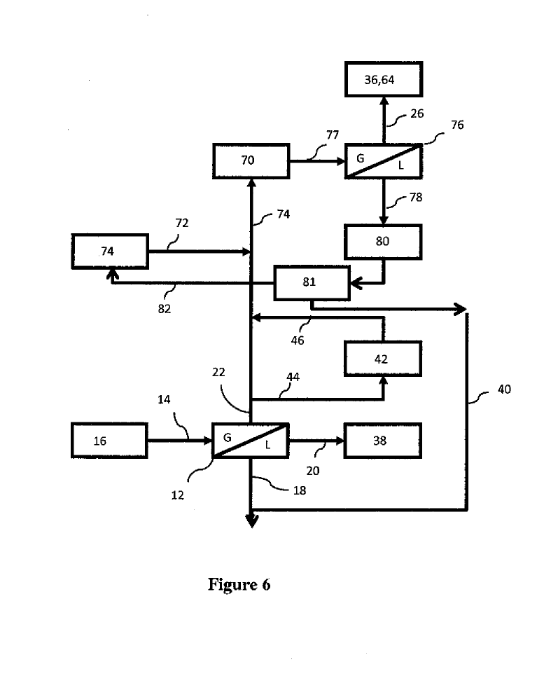

A third embodiment of the present invention which relies on the chilling of the unsweetened gas is now described with reference to FIG. 6. In this embodiment, the first operating pressure of the gas containment system is in range of 100 to 150 bar (1450 to 2100 psi) and the first operating temperature is below zero degrees Celsius, preferably in the range of −25 to −40 degrees Celsius. In this embodiment, there is no requirement to subject the unstabilised condensate stream to chilling prior to storage in the condensate containment system. To achieve these low temperatures, the dew-pointed unsweetened natural gas stream (22) is subjected to chilling using a chiller (70) prior to the storage of at least a portion of the partially dehydrated unsweetened natural gas stream (26) in the gas containment system (36). Chilling of the dew-pointed unsweetened natural gas stream requires a high selected level of dehydration of less than 5 mg/Sm³. One way of achieving this high level of dehydration is through the use of a molecular seive. Alternatively, a high level of dehydration can be achieved using an injection of a liquid desiccant. With reference to FIG. 6, the liquid dessicant is formed by injection of a stream of dry MEG (72) from a dry MEG storage unit (74) into the dew-pointed unsweetened natural gas stream (22) upstream of the chiller (70) to produce a MEG treated unsweetened natural gas stream (75) that is then fed to the chiller (70) in order to prevent the possible formation of ice and or gas hydrates in the chiller (70). A gas/liquid separator (76) is located downstream of the chiller (70) to receive a chilled MEG treated unsweetened natural gas stream (77) from the chiller (70) and produce the partially dehydrated unsweetened natural gas stream (26), which has a high level of dehydration, and, a liquid stream containing MEG (78) which is hereinafter referred to as a wet MEG stream. The wet MEG stream (78) is stored in a wet MEG storage unit (80) while the partially dehydrated unsweetened natural gas stream (26) is directed to the buffer gas containment system (64) located on the floating structure (60) or fed directly into the gas containment system (36) of the gas carrier vessel (28). The wet MEG stream (78) is directed to a wet MEG storage unit (80) for storage. The wet MEG stream may be treated in a MEG recovery unit (81) to produce a regenerated dry MEG stream (82) which is fed to the dry MEG storage unit (74), and a water stream (40). The regenerated dry MEG stream (82) is recycled in this way to be re-used as a portion of the dry MEG stream (72). The MEG recovery unit (81) is used to keep liquid desiccant storage to a minimum. To keep the topside complexity of the gas carrier vessel (28) to a minimum, the chiller (70), the gas/liquid cold separator (76), the MEG recovery unit (81) and one or both of the wet MEG storage unit (80) and the dry MEG storage unit (74) may be located on the floating structure (60) as illustrated in FIG. 5.

In an alternative embodiment illustrated in FIG. 7, the gas-liquid separator (12) is located on the seabed (51) while the dry MEG storage unit (74), the chiller (70), the gas/liquid cold separator (76), the MEG recovery unit (81) and the wet MEG storage unit (80) are all located on the gas carrier vessel (28). The compression facility (42) may be located on the gas carrier vessel (28) or on the floating structure (60). In this embodiment, the wet MEG stream is transported as part of the cargo onboard the gas carrier vessel (28) from the supply location (16) to the offloading location (30). This reduces the complexity of the topsides of the floating structure (60). As an alternative, the wet MEG stream (78) may be offloaded to a MEG recovery unit (81) associated with a dehydration facility (37) which forms a part of an LNG production facility (35). A regenerated dry MEG stream is then returned to the gas carrier vessel (28) after offloading of the unsweetened natural gas at the offloading location (30). In the embodiment illustrated in FIG. 7, the gas/liquid separator (12) is located at the seabed (51) so that the free water stream (18) may be disposed of via an injection well (86) using an associated subsea pumping system (88). This embodiment keeps the complexities and thus the cost of the topsides of the floating structure (60) to a minimum.

The floating structure (60) is provided with a power generation system (90) for generating electricity capable of providing power to the gas/liquid separator (12), the dehydration unit (24) and associated valves and pumps. The power generation system (90) may use gaseous or liquid hydrocarbons as fuel to produce electricity. When the system includes a compression facility (42), a chiller (70), a separator (76) and/or a MEG recovery unit (81) at the supply location (16), the power generation system (90) may be used to provide power to these units and their associated valves and pumps as well. Additionally, when one or both of the gas/liquid separator (12) and the compression facility (42) is located subsea, the power generation system (90) of the floating structure (60) may also provide power to an associated subsea pumping system (88) using suitable power umbilicals known in the relevant art. The power generation system (90) may also be used to provide power to any of these units when they located on the gas carrier vessel (28).

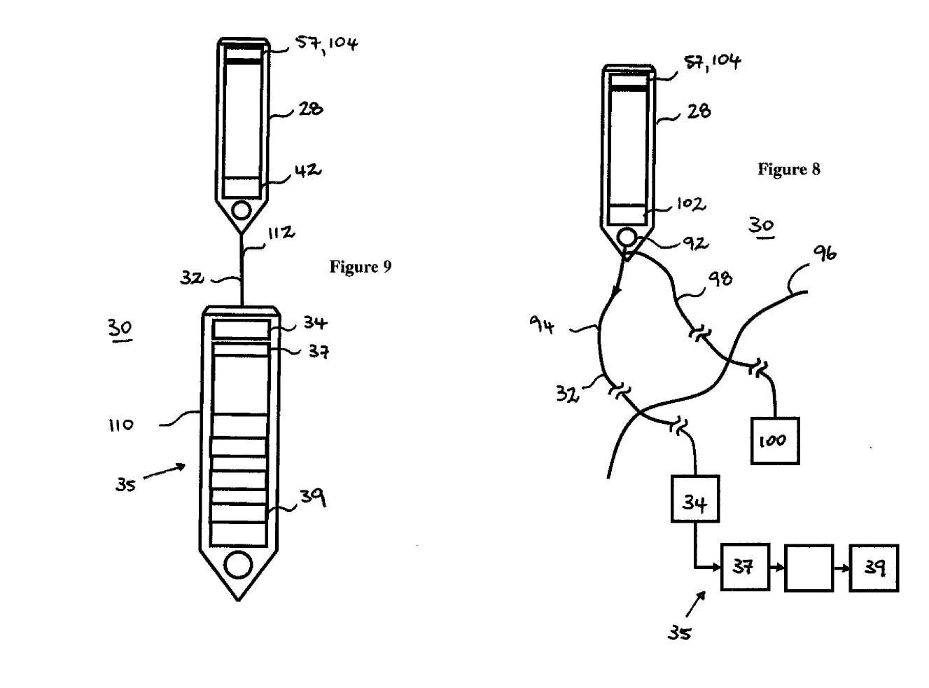

A first embodiment of the offloading location (30) associated with an acid gas removal facility (34) is now described with reference to FIG. 8 in which the acid gas removal facility (34) is located onshore. In this embodiment, the acid gas removal facility (34) receives a feed source of unsweetened natural gas (32) which includes the partially dehydrated unsweetened gas (26) from the gas containment system (36). The acid gas removal facility (34) is used to remove sour gas species (and carbon dioxide) to produce a stream of sweet gas which is fed to an LNG production facility (35) that is also located onshore. The gas carrier vessel (28) is moored at the offloading location (30) using a submersible turret mooring system (92) which includes a buoy and a gas delivery line (94) for delivery of the partially dehydrated unsweetened gas stream (26) across the shore (96) to the onshore acid gas removal facility (34). The gas carrier vessel cargo may equally be offloaded using a rigid arm connection over the bow of the gas carrier vessel to a riser turret mooring, or a bow loading system using a Single Anchor Leg Mooring (“SALM”) system. The gas carrier vessel may equally offload its cargo after docking at a suitable jetty. Where prevailing weather is highly directional, spread mooring can be used as an alternative, however, such locations are not common.

The unstabilised condensate (20) from the condensate containment system (38) may be offloaded via a separate liquid delivery line (98) to a condensate storage facility (100) located onshore for further treatment. Alternatively, if required, the partially dehydrated unsweetened gas stream (26) can be blended with the unstabilised condensate (and, optionally, other sources of feed gas) at the offloading location (30) whereby the feed source of unsweetened gas (32) is in the form of a blended stream to ensure that the overall feed gas composition falls within the operating envelope of the LNG production facility (35) associated with the acid gas removal facility (34).

If, by way of example, the unstabilised condensate (20) has been stored at ambient temperature in the condensate containment system (38) and the partially dehydrated unsweetened gas stream (26) which has been stored in the gas containment system (36) was chilled prior to transport, then the condensate (20) and unsweetened gas (26) may be blended so that the feed source of unsweetened gas (32) meets the delivery conditions of temperature at the offloading location (30). Alternatively or additionally, the system (10) may include a heat exchanger (102) to heat at least a portion of the partially dehydrated unsweetened gas stream (26) to meet delivery conditions of temperature at the offloading location (30), using a source of waste heat, for example, waste heat recovered from the power generation system (57), or the propulsion system (104) of the gas carrier vessel (28). Alternatively, electric heaters, ambient air vaporisers or submerged combustion heaters may be used if a source of waste heat is not available or the available waste heat is insufficient. Direct fired heating may be used but is not preferred. Heating of the chilled partially dehydrated unsweetened gas stream prior to offloading may be used to avoid the need to use exotic materials of construction at the offloading location and to mitigate the formation of ice and or gas hydrates during offloading operations.

If the first operating pressure of the gas containment system (36) onboard the gas carrier vessel (28) is higher than the system inlet pressure at the offloading location (30), the partially dehydrated unsweetened gas stream (26) can be used to help to displace the unstabilised condensate (20) from the condensate containment system (38). If the first operating pressure of the gas containment system (36) is lower than the system inlet pressure at the offloading location (30), then compression of the partially dehydrated unsweetened gas stream (26) may be needed during offloading. Such compression may be provided using an onboard compression facility (42) for embodiments in which the gas carrier vessel (28) is fitted with a compression facility (42). Alternatively, compression may be provided using gas compression facility (39) associated with the acid gas removal facility (34) or the LNG production facility (35) located at the offloading location (30). If the second operating pressure of the condensate containment system (38) is lower than the system inlet pressure at the offloading location (30), a pump (not shown) may be used to offload the unstabilised condensate (20) from the condensate containment system (38).

A second embodiment of the offloading location associated with an acid gas removal facility (34) is now described with reference to FIG. 9 in which the acid gas removal facility (34) is located offshore to provide gas pre-treatment for a floating LNG production facility (110). Upon arrival of the gas carrier vessel (28) at the floating LNG production facility (110), the partially dehydrated unsweetened gas stream (26) is fed as a feed source of unsweetened gas (32) to an acid gas removal facility (34) which forms part of the floating LNG production facility (110) via a gas delivery line (112). In FIG. 9, the gas carrier vessel (28) and the floating LNG facility (110) are shown in a bow to stern arrangement during offloading operations. The gas carrier vessel and the floating LNG facility may equally be in a side-by-side arrangement during offloading. This allows the floating LNG facility to be located in a benign sheltered environment which helps with motion sensitive process equipment, offloading systems and LNG storage. If required, the partially dehydrated unsweetened gas stream (26) can be blended with the unstabilised condensate (20) and other sources of gas to ensure that the overall feed gas composition of the blended stream (32) falls within the operating envelope of the LNG production facility as described above. If the gas carrier vessel (28) is not fitted with a gas compression facility (42) and feed gas compression is required when the partially dehydrated unsweetened gas stream (26) and condensate (20) are offloaded from the gas carrier vessel (28) to the floating LNG facility (110), then such gas compression can be provided using a gas compression facility (39) associated with the floating LNG production facility (110).

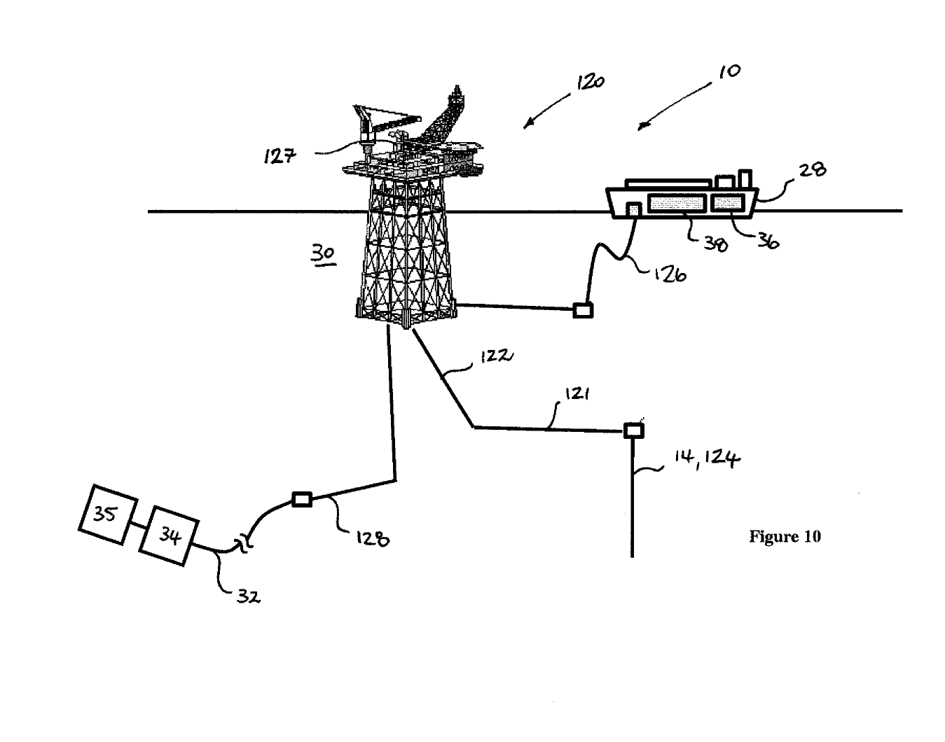

A third embodiment of an offloading location is now described with reference to FIG. 10 in which the acid gas removal facility (34) is at an offloading location (30) in the form of an offshore gas processing hub (120). In this embodiment, the gas processing hub (120) receives at least one source of raw natural gas (121) via a production riser (122) associated with a subsea well (124) located adjacent to or in the vicinity of the gas processing hub (120). The partially dehydrated unsweetened gas stream (26) is offloaded from the gas carrier vessel (28) via a gas delivery line (126). At least a portion of the partially dehydrated unsweetened gas stream (26) may be blended with the at least one source of raw natural gas (121) at the gas processing hub (120) to form a blended stream (123) which is delivered through an export pipeline (128) from the gas processing hub (120) as a blended feed source of natural gas (32) to an onshore acid gas removal facility (34) associated with an onshore LNG production facility (35). The condensate (20) stored onboard the gas carrier vessel (28) may be added to the blended stream (123) as well or subjected to further processing at the gas processing hub (120) for future sale as stabilized condensate or used as a fuel for generating electricity to power equipment associated with the gas processing hub. If the gas carrier vessel (28) is not fitted with a gas compression facility (42) and feed gas compression is required when the partially dehydrated unsweetened gas stream (26) and unstabilised condensate (20) are being offloaded at the gas processing hub (120), then such gas compression can be provided by a gas compression facility (127) already located at the gas processing hub (120). This embodiment is particularly suited to a scenario where the supply location is a stranded or sour gas field which is located sufficiently far away from the gas processing hub that the costs associated with laying a pipeline from the stranded or sour gas field to the gas processing hub are prohibitive. By way of example, the gas carrier vessel may travel a distance of 500 to 1000 kilometers from the stranded or sour gas field to deliver its cargo to the gas processing hub while the gas processing hub may be located up to 1000 kilometers from the LNG production facility.

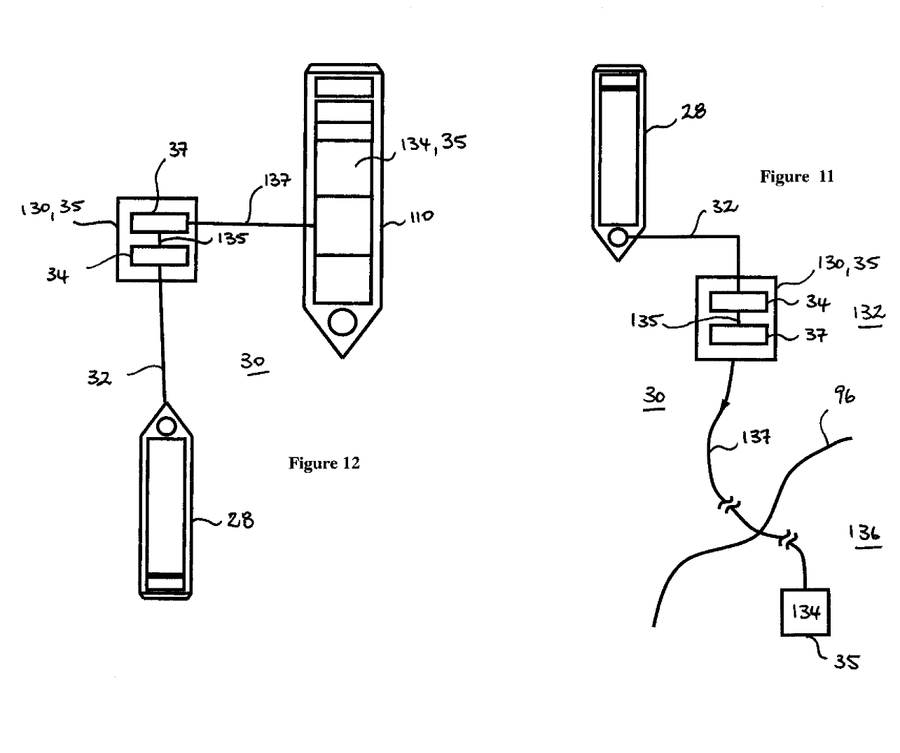

A typical LNG production facility includes at least a gas pre-treatment facility which includes dehydration and acid gas removal facilities for the removal of freezable solids prior to liquefaction, and a liquefaction facility comprising a main cryogenic heat exchanger and associated refrigerant compression facilities. The level of dehydration required prior to liquefaction is less than 5 parts per million, requiring the use of molecular sieves. Depending on the feed gas composition, an LNG production facility may further comprise a mercury removal facility, a nitrogen recovery facility, a heavy hydrocarbon recovery facility and facilities for storing and shipping the LNG to another location. A fourth embodiment of the offloading location (30) associated with an LNG production facility (35) is now described with reference to FIGS. 11 and 12 in which the LNG production facility (35) comprises a gas processing facility (130) including an acid gas removal facility (34) and a dehydration facility (37) at a first location (132), the first location (132) being spaced apart from a liquefaction facility (134) at a second location (136). Advantageously, the second location (136) may be selected as a location that has more benign environmental conditions than the first location (132). In FIG. 11, the gas processing facility (130) is a fixed barge or floating structure and the first location (132) is offshore while the second location (136) for the liquefaction facility (134) is onshore. In the embodiment illustrated in FIG. 12, the gas processing facility (130) is located on a floating structure or vessel offshore while the liquefaction facility (134) for the LNG production facility (35) are located on a floating LNG vessel (110) located offshore. In both embodiments, the acid gas removal facility (34) of the gas processing facility (130) receives the partially dehydrated unsweetened gas stream (26) from the gas carrier vessel (28) and produces a stream of partially dehydrated sweetened gas (135) to the dehydration unit (37). The dehydration subjects the partially dehydrated sweetened gas (135) to further dehydration to produce a dry sweetened gas (137) which is then fed to the liquefaction facility (134) which produces LNG for export.

On the return journey from the offloading location (30) to the supply location (16), one or both of the gas containment system (36) or the condensate containment system (38) of the gas carrier vessel (28) can be loaded with byproducts of the acid gas removal facility (34) or the LNG production facility (35), such as LPG, stabilized condensate, or carbon dioxide, or other products like propane and butane which can be used as fuel. To facilitate this, the gas carrier vessel (28) may be provided with a plurality of chambers, each chamber being capable of storing a gas or a liquid. Using this arrangement, a first subset of the plurality of chambers may be designated for use as the gas containment system onboard the gas carrier vessel as it travels from the supply location to the offloading location, whilst a second subset of the plurality of chambers may be designated for use as the liquid containment system onboard the gas carrier vessel for the same journey. A third subset of the plurality of chambers may be designated for use as the wet MEG storage unit onboard the gas carrier vessel as it travels from the supply location to the offloading location. A fourth subset of the plurality of chambers may be designated for use as the dry MEG storage unit onboard the gas carrier vessel as it travels from the offloading location to the supply location. The specific number of chambers included in each of the first, second, third and fourth subsets will depend on such relevant factors as the composition of the raw natural gas at the supply location and the demand for unstabilised condensate to be used for blending at the offloading location. This provides flexibility as to the type of cargo that the gas carrier vessel can transport from the supply location to the offloading location and also the type of cargo that the gas carrier vessel transports from the offloading location to the supply location on the return journey. To facilitate offloading of liquids and solids, each chamber is provided with a liquids drainage outlet. To facilitate offloading of gases, each chamber is provided with a gas discharge outlet.

In one preferred embodiment of the present invention, now described with reference to FIG. 10, a stream of carbon dioxide is loaded into a fifth subset of the plurality of chambers onboard the gas carrier vessel for re-injection into an offshore storage reservoir where the carbon dioxide can be safely stored in the ground instead of being released into the atmosphere where it would act as a greenhouse gas. The carbon dioxide may be sourced from any suitable location seeking to reduce its carbon footprint but is most advantageously sourced as a byproduct of the LNG production facility or from a power plant associated with the LNG production facility. Prior to loading, water should be removed from the carbon dioxide using a suitable dehydration unit to protect the gas containment system from corrosion. The carbon dioxide may be transported as a liquid, a gas, a dense phase gas or a supercritical fluid, depending on the operating pressure and temperature of the gas containment system onboard the gas carrier vessel. By way of example, if the operating pressure of the gas containment system onboard the gas carrier vessel is in the range of 200 to 250 bar (2900 to 3600 psi) at ambient temperature, then the carbon dioxide can be transported as a dense phase fluid which is added to the gas containment system of the gas carrier vessel as the partially dehydrated unsweetened gas stream (26) is being offloaded. Alternatively, if the first operating pressure of the gas containment system is in range of 100 to 150 bar (1450 to 2100 psi) with an operating temperature in the range of −25 to −35 degrees Celsius, then the carbon dioxide is transported as a cold liquid which can be used, at least in part, to provide cooling for the chiller (70) at the supply location or to provide cooling as required at another reservoir where the carbon dioxide is to be re-injected. If the carbon dioxide stream requires cooling and/or compression to match the desired storage temperature and pressure conditions prior to storage onboard the gas carrier, the chiller (70) and the compression facility (42) onboard the gas carrier vessel (28) may be used for this duty. If the gas carrier vessel (28) is not fitted with a chiller, cooling can equally be provided by equipment located at the LNG production facility (35) at the offloading location (30). In an analogous manner, if the gas carrier vessel (28) is not fitted with a compression facility, gas compression can be provided by equipment located at the LNG production facility (35) at the offloading location (30).

The size of the gas containment system (36) and the condensate containment system (38) of the gas carrier vessel (28) may vary. By way of example, the gas containment system may be capable of storing between 2 to 30 million standard cubic metres of gas while the condensate containment system may be capable of storing between 200 to 10,000 cubic meters of condensate. If the gas carrier vessel capacity is greater than the demand for partially dehydrated unsweetened gas at a first acid gas removal facility, then the gas carrier vessel may sail away to another offloading location to unload any remaining cargo at a second acid gas removal facility. In the event that there is no acid gas removal facility available to receive the partially dehydrated unsweetened gas stream, for example, due to a shutdown of the LNG production facility associated with the acid gas removal facility, the partially dehydrated unsweetened gas stream (26) may be offloaded as a source of feed gas to an acid gas removal facility associated with a domestic gas processing plant, electric power generation station or an existing onshore or offshore gas processing hub.

To further minimize the costs associated with the design and construction of the gas carrier vessels, it is desirable that the design of the gas carrier vessel is replicated many times to keep the unit cost to a minimum.

Now that several embodiments of the invention have been described in detail, it will be apparent to persons skilled in the relevant art that numerous variations and modifications can be made without departing from the basic inventive concepts. By way of further example, the condensate may be subjected to additional treatment using a condensate stabilization facility onboard the gas carrier vessel or onboard the floating structure to produce a saleable condensate product for use as fuel or as a feed to an oil refinery. All such modifications and variations are considered to be within the scope of the present invention, the nature of which is to be determined from the foregoing description and the appended claims.

All of the patents cited in this specification, are herein incorporated by reference. It will be clearly understood that, although a number of prior art publications are referred to herein, this reference does not constitute an admission that any of these documents forms part of the common general knowledge in the art, in Australia or in any other country. In the summary of the invention, the description and claims which follow, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of marine transportation of natural gas comprising the steps of:
a) removing a free water stream and a condensate stream from the source of raw natural gas to produce a dew-pointed unsweetened natural gas stream at an offshore supply location;
b) subjecting the dew-pointed unsweetened natural gas stream to a selected level of dehydration to produce a partially dehydrated unsweetened natural gas stream at the offshore supply location;
c) transporting at least a portion of the partially dehydrated unsweetened natural gas stream in a gas containment system onboard a gas carrier vessel from the offshore supply location as a feed source of natural gas to an acid gas removal facility or an LNG production facility located at an offloading location.

2. The method of claim 1 wherein the gas containment system has a first operating pressure in the range of 200 to 250 bar, and the gas containment system has a first operating temperature is at ambient temperature or near-ambient temperature, and wherein the level of dehydration is less than 200 mg/Sm³.

3. The method of claim 1 wherein the gas containment system has a first operating pressure in range of 100 to 150 bar, and the gas containment system has a first operating temperature is in the range of −25 to −40 degrees Celsius, and wherein the level of dehydration is less than 5 mg/Sm³.

4. The method of claim 1 wherein the gas containment system has a first operating temperature below zero degrees Celsius and the method includes the step of chilling at least a portion of the dew-pointed unsweetened natural gas stream to form a chilled gas stream having a level of dehydration less than 5 mg/Sm³.

5. The method of claim 1 wherein the gas containment system has a first operating pressure in the range of 200 to 250 bar, and the gas containment system has a first operating temperature is at ambient temperature or near-ambient temperature, and wherein dew-pointed unsweetened gas is treated with a liquid or solid desiccant to achieve the selected level of dehydration of less than 200 mg/Sm³.

6. The method of claim 5 wherein a liquid desiccant is formed by injection of a stream of glycol into a portion of the dew-pointed unsweetened natural gas stream prior to the step of subjecting the dew-pointed unsweetened natural gas stream to chilling.

7. The method of claim 6 comprising the step of recovering the glycol in a glycol recovery unit.

8. The method of claim 7 wherein the step of recovering the glycol is conducted onboard the gas carrier.

9. The method of claim 7 wherein the step of recovering the glycol is conducted at the offloading location.

10. The method of claim 1 including the step of subjecting the dew-pointed or partially dehydrated unsweetened gas stream to compression prior to loading onboard the gas carrier vessel.

11. The method of claim 1 wherein step c) includes transporting at least a portion of the condensate stream in a condensate containment system onboard the gas carrier vessel from an offshore supply location to an offloading location.

12. The method of claim 11 wherein the gas containment system has a first operating pressure and the condensate containment system has a second operating pressure, and wherein the first operating pressure is matched to the second operating pressure and step c) includes regulating the ratio of condensate to gas to form a blended stream having a feed gas composition that falls within the operating envelope of the acid gas removal facility or an LNG production facility.

13. The method of claim 1 wherein the supply location is a deepwater gas reservoir, a stranded gas reservoir, a sour gas reservoir, a stranded gas pool, or gas associated with an oil reservoir.

14. The method of claim 1 wherein the offshore supply location is located 100 to 1,000 km from the offloading location.

15. The method of claim 1 wherein the acid gas removal facility is located onshore or offshore.

16. The method of claim 1 wherein the acid gas removal facility is associated with an LNG production facility.

17. The method of claim 1 wherein the LNG production facility is a fixed or floating LNG production facility.

18. The method of claim 1 wherein at least a portion of the partially dehydrated unsweetened natural gas stream is blended with at least one source of natural gas at a gas processing hub to form a blended stream delivered through an export pipeline from the gas processing hub as the feed source of natural gas to the acid gas removal facility of the LNG production facility.

19. The method of claim 18 wherein the gas carrier vessel travels a distance of 500 to 1000 kilometers from the supply location to the gas processing hub and the gas processing hub is located no more than 1000 kilometers from the LNG production facility.

20. The method of claim 1 wherein the acid gas removal facility is positioned at a first location for receiving the partially dehydrated unsweetened natural gas from the gas carrier vessel to produce a sweetened natural gas stream for delivery to a second location that is spaced apart from the first location, and wherein a liquefaction facility which produces LNG is positioned at the second location.

21. The method of claim 1 including the step of returning the gas carrier vessel from the offloading location to the supply location with the gas carrier vessel being loaded with one or more byproducts of an LNG production facility.

22. The method of claim 21 wherein the one or more byproducts of the LNG production facility is liquefied petroleum gas, stabilized condensate, carbon dioxide, propane, butane or dry monoethylene glycol.

23. The method of claim 21 wherein the step of returning the gas carrier vessel from the offloading location to the supply location comprises loading a stream of carbon dioxide onboard the gas carrier vessel for re-injection into an offshore storage reservoir.

24. The method of claim 1 wherein the supply location is one of a plurality of supply locations.

25. A system for marine transportation of natural gas comprising:
a gas/liquid separator for receiving a source of raw natural gas from an offshore supply location and removing a free water stream and a condensate stream from the source of raw natural gas to produce a dew-pointed unsweetened natural gas stream;
a dehydration unit for subjecting the dew-pointed unsweetened natural gas stream to a selected level of dehydration to produce a partially dehydrated unsweetened natural gas stream at the offshore supply location;
a gas carrier vessel for transporting at least a portion of the partially dehydrated unsweetened natural gas stream in a gas containment system onboard a gas carrier vessel from the offshore supply location as a feed source of natural gas to an acid gas removal facility or an LNG production facility located at an offloading location.

26. The system of claim 25 wherein the LNG production facility is a fixed or floating LNG production facility.

27. The system of claim 25 wherein the supply location is located 100 to 1000 km from the offloading location.

28. The system of claim 25 wherein the supply location is a deepwater gas reservoir, a stranded gas reservoir, a stranded gas pool, a sour gas reservoir, or gas associated with an oil reservoir.

29. The system of claim 28 wherein the supply location is one of a plurality of supply locations.

30. The system of claim 25 including a gas containment system onboard the gas carrier vessel for storing at least a portion of the partially dehydrated unsweetened natural gas at a first operating pressure and a first storage temperature.

31. The system of claim 25 including a condensate containment system onboard the gas carrier vessel for storing at least a portion of the condensate stream at a second operating pressure and a second storage temperature.

32. The system of claim 25 further comprising a compression facility for subjecting the dew-pointed natural gas stream or the partially dehydrated unsweetened natural gas stream to compression prior to loading onboard the gas carrier vessel.

33. The system of claim 32 wherein the compression facility is located upstream or downstream from the dehydration unit.

34. The system of claim 32 wherein the dehydration unit and the compression facility are located onboard the gas carrier vessel.

35. The system of claim 25 wherein the gas/liquid separator is located on the seabed.

36. The system of claim 32 wherein the compression facility is located on the seabed

37. The system of claim 25 wherein the gas carrier vessel includes a power generation system for generating electricity capable of providing power for transportation of the gas carrier vessel from the supply location to the offloading location.

38. The system of claim 37 wherein the power generation system provides power to one or all of the compression facility, the dehydration unit, and the gas/liquid separator.

39. The system of claim 25 wherein the gas/liquid separator, the compression facility, and the dehydration unit are located on a floating structure at a supply location.

40. The system of claim 39 wherein the floating structure comprises a buffer gas containment system for storage of a portion of the partially dehydrated unsweetened natural gas stream.

41. The system of claim 39 wherein the floating structure comprises a buffer liquid containment system for storage of a portion of the condensate stream.

42. The system of claim 39 to wherein the floating structure is a marine transportation vessel, a semi-submersible platform, a tender-assisted self-erecting structure, a tension-leg platform, a normally unmanned platform, a satellite platform, or a spar.

43. The system of claim 30 including a chiller for chilling of at least a portion of the partially dehydrated unsweetened natural gas prior to storage in the gas containment system.

44. The system of claim 43 further comprising a glycol storage unit for providing a stream of glycol for injection into the dew-pointed natural gas stream upstream of the chiller.

45. The system of claim 44 including a glycol recovery unit for regenerating glycol.

46. The system of claim 45 wherein the glycol recovery unit is a part of the LNG production facility or an acid gas removal facility.

47. The system of claim 43 wherein the chiller and the glycol recovery unit are located on a floating structure.

48. The system of claim 25 wherein the chiller is located on the gas carrier vessel.

49. The system of claim 25 wherein the LNG production facility is located onshore or offshore whilst the offloading location is an offshore gas processing hub arranged to receive at least one source of natural gas via a production riser associated with a subsea well located adjacent to or in the vicinity of the gas processing hub.

50. The system of claim 25 wherein at least a portion of the partially dehydrated unsweetened natural gas is blended with the at least one source of natural gas to form a blended stream delivered through an export pipeline from the gas processing hub as the feed source of natural gas to the LNG production facility.

51. The system of claim 25 wherein the gas carrier vessel travels a distance of 500 to 1000 kilometers from the supply location to the gas processing hub while the gas processing hub is located no more than 1000 kilometers from the LNG production facility.

52. The system of claim 25 wherein the LNG production facility includes a gas processing facility at a first location spaced apart from a liquefaction facility at a second location.

53. The system of claim 52 wherein the gas processing facility receives the partially dehydrated unsweetened natural gas from the gas carrier vessel and delivers a stream of dry sweet natural gas to the liquefaction facility which produces LNG.

54. The system of claim 52 wherein the gas processing facility is positioned on a fixed barge or floating structure and the first location is offshore while the second location is onshore.

55. The system of claim 25 wherein the gas processing facility is located on a floating structure or vessel offshore while the liquefaction facility is located on a floating LNG vessel and the second location is offshore.
